(19) United States
(12) Patent Application Publication
(10) Pub. No.: US 2011/0319040 A1
(43) Pub. Date: Dec. 29, 2011

(54) RF INTEGRATED CIRCUIT FOR DEVELOPMENT

(75) Inventors: Yukio Obuchi, Saitama-shi (JP); Yoshiaki Mayuzumi, Saitama-shi (JP)

(73) Assignee: COSMO RESEARCH CO., LTD., Saitama-shi (JP)

(21) Appl. No.: 12/822,039

(22) Filed: Jun. 23, 2010

(51) Int. Cl. H04B 1/44

(52) U.S. Cl. 455/83

(57) ABSTRACT

It is become accumulation independently with physical layer circuit and the MAC circuit, and an RF integrated circuit for development for the radio transmission and reception that the interface frequency with the physical layer circuit has width of at least around 10 MHz toward is related to. It is RF integrated circuit 1 for the development that the switching circuit which changes a demodulation circuit and a modulation circuit and an antenna to either of demodulation circuit 11 and modulation circuit 12 was built in, and RF integrated circuit 1 is made accumulation independently with physical layer circuit 21 and MAC circuit 22 and demodulation circuit 11 converts a received radio frequency signal into a frequency signal of frequency 5-20 MHz, and modulation circuit 12 converts a frequency signal of frequency 5-20 MHz into a radio frequency signal.

### FIELD OF THE INVENTION

The present invention relates to an RF integrated circuit suitable for development made accumulation independently about an RF integrated circuit for development specifically with physical layer circuit and the MAC circuit.

### BACKGROUND ART

In our country (Japan), the analog television broadcast is finished in July, 2011, and it shifts to digital television broadcasting. In recent times, analog television broadcast is finished abroad, and countries shifting to digital television broadcasting increase. In our country, the 700 MHz belt (around 10 MHz of 715M-725 MHz) which analog television broadcast uses currently is used for ITS (IntelligentTransportSystems). The ITS is applied to the communication between the car for before the fact to prevent the collision of the car.

Also, WiMAX (IEEE802.16:) to do when the high-speed wireless Internet that can use the high-speed Internet during whereabouts and movement can be used Worldwide Interoperability for Microwave Access) is spreading, too. Besides, in a personal institution or public accommodation, the usable environment is having good wireless LAN.

As shown in FIG. 7, with communications equipment 8 used for ITS, iMAX, wireless LAN, that the radio return modulation circuit (RF circuit 81) is made accumulation integrally with physical layer circuit (a PHY layer circuit) 82 and MAC circuit (media access control circuit) 83 (i.e., as 1 tip), and it is made is assumed at the time of the product installation (cf. patent document the first class).

The frequency (analog frequency) that physical layer circuit 82 handles is often different every development as having said 5 MHz in 10 MHz, the wireless LAN by 10 MHz, the WiMAX in the ITS. Thus, by the development of communications equipment 8 of the constitution of FIG. 7, RF circuit 81 must be designed again each time. Therefore, it is not realistic from a surface of the expense that RF circuit 91 becomes accumulation alone.

Thus, as shown in FIG. 8, RF circuit 91 of the development process is formed to the substrate of the anomalous style in the development of communications equipment 9 with physical layer circuit 92 of the development process and MAC circuit 93. Note that, physical layer circuit 92 and MAC circuit 93 is constructed to be able to support the frequency of the signal to receive from RF circuit 91, and a change is not needed. Therefore, it is preferable as substrate constitution, and physical layer circuit 92 and MAC circuit 93 may use a Pan-article made an integrated circuit as shown in FIG. 8.

Related technologies are described, for example, in Japanese Patent Laid-Open No. 2007-215,174.

### SUMMARY OF THE INVENTION

### Problem to be Solved by the Invention

However, because RF circuit 91 shown in FIG. 8 is not made accumulation, a noise due to the guidance of the signal line occurs, and incommodiousness may produce for development. For example, because when a development circuit with the substrate is applied to an integrated circuit, the inconsistency of the scale often occurs, the application to an integrated circuit is not easy. It becomes the problem to break off such an inconvenience conventionally.

The object of the present invention is to provide an RF integrated circuit for development that it is become physical layer circuit and the MAC circuit accumulation independently, and the interface frequency with the physical layer circuit has width of at least around 10 MHz toward.

### Means to Solve the Problem

(1) An RF integrated circuit for development including a radio frequency band signal received by an antenna is reduced to arbitrary frequency, and a signal of option frequency input into other circuits from a demodulation circuit to output and the circuit of above others is raised in a radio frequency, and it is an RF integrated circuit for development that had the switching circuit which changes a modulation circuit to output and an above antenna to either of an above demodulation circuit and the above modulation circuit built-in, and the RF integrated circuit is made accumulation independently with the circuit of above others by an above antenna and the above demodulation circuit converts a received radio frequency signal into a frequency signal of frequency 5-20 MHz, and the above modulation circuit converting a frequency signal of frequency 5-20 MHz into a radio frequency signal.

(2) The other circuits, an RF integrated circuit for development as claimed in (1) including the thing including media access control circuit connected to the physical layer circuit which AD conversion is performed between the demodulation circuit, and performs DA conversion between the modulation circuit and the physical layer circuit

(3) An RF integrated circuit for development including the thing comprising the switch circuitry which it is an RF integrated circuit for development as claimed in (1) that a return modulation circuit functioning as the demodulation circuit and the modulation circuit was built in, and the return modulation circuit changes the signal paths that at least send out the signal from a low noise amplifier and image f\check{S}fWfFfNfVf‡f″ Ef˜fLfT of the latter half and the signal paths that the power amplifier of the latter half is further included as common componentry, and send out the signal from an above antenna to an above physical layer circuit through the return modulation circuit and an above physical layer circuit to an above antenna through the return modulation circuit to.

Image f\check{S}fWfFfNfVf‡f″ Ef˜fLfT can be comprised from a synthesizer each signal from the second mixer multiplying the other of 2 signals which generated a share wave by the other and above the first place caliber of leadership among 2 done signals by the first mixer which multiplies one of 2 signals which generated a share wave by one and above the first place caliber of leadership among 2 done signals by a splitter doing a share wave and an above splitter by 2 signals having a phase difference of 90 degrees and above splitter by and the first above mixer and the second mixer is input, and to add caliber of leadership and an input signal to as the aspect so as to generate 2 signals having a phase difference of 90 degrees from the oscillation signal of the local oscillator. Also, Image f\check{S}fWfFfNfVf‡f″ Ef˜fLfT can be comprised from a synthesizer each signal from the second mixer multiplying the other of 2 signals which generated a share wave by the other and above the first place caliber of leadership among 2 done signals by the first mixer which multiplies one of 2 signals which generated a share wave by one and above the first place caliber of leadership among 2 done signals by a splitter doing a share wave and an above splitter by 2 signals in a coordinate aspect and above splitter by and the first above mixer and the second mixer is input, and 90 degrees phase shifting does one input signal, and to add caliber of leadership and an input signal to so as to generate 2 signals having a phase difference of 90 degrees from the oscillation signal of the local oscillator.

### Effect of the Invention

Even if frequency is different every development because there is, with the RF integrated circuit for development of the present invention, width does not have to design the RF circuit again each time to the interface frequency with other circuits.

According to the present invention, in an RF integrated circuit, it is elaborated a frequency converter circuit to convert a signal (e.g., from 5 MHz 20 MHz) of the frequency from a physical layer circuit into a radio signal (e.g., 700 MHz is worn) and a frequency converter circuit to convert a radio signal (e.g., 700 MHz is worn) into a signal (e.g., from 5 MHz 20 MHz) for physical layer circuits as an IC. Thereby, if it is the return modulation circuit where a physical layer circuit works in a predetermined range (e.g., a range from 5 MHz to 20 MHz), it can be developed using an RF integrated circuit (the RF integrated circuit of the same specifications) of the present invention.

### BRIEF DESCRIPTION OF DRAWINGS

FIG. 1 is a circuit diagram showing one embodiment of the present invention, and it is the block diagram showing the state that an RF integrated circuit is connected to physical layer circuit and MAC circuit.

FIG. 2 is a block diagram the demodulation circuit of the RF integrated circuit of FIG. 1 and a modulation circuit are subdivided, and to show.

FIG. 3 is a figure showing an RF integrated circuit of FIG. 1 specifically.

FIG. 4 (A) is a figure showing image f\check{S}fWfFfNfVf‡f″ Ef˜fLfT of the demodulation circuit of ,Í FIG. 3 is a figure showing image f\check{S}fWfFfNfVf‡f″ Ef˜fLfT of the modulation circuit of ,Í,Í FIG. 3 (B).

FIG. 5 shows, in an RF integrated circuit of the present invention, the conceptual diagram of the principle showing the return modulation circuit which shares a modulation circuit with a demodulation circuit by one circuit.

FIG. 6 is the illustration shown in the details with RF integrated circuit 1 of FIG. 5 more.

FIG. 7 is the block diagram showing the conventional communication circuitry.

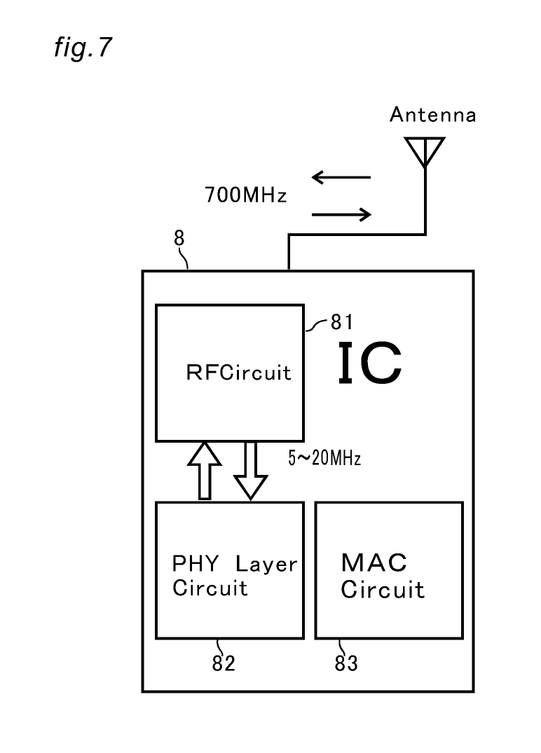

FIG. 8 is the block diagram showing the circuit for development of the conventional communication circuitry.

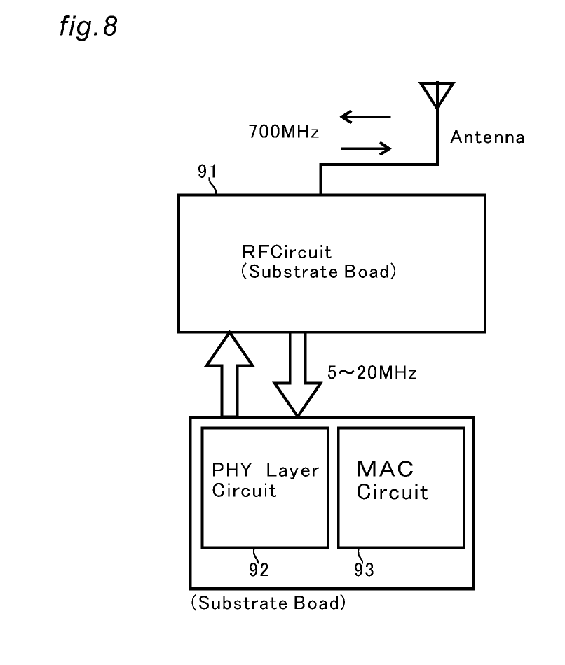

### DETAILED DESCRIPTION

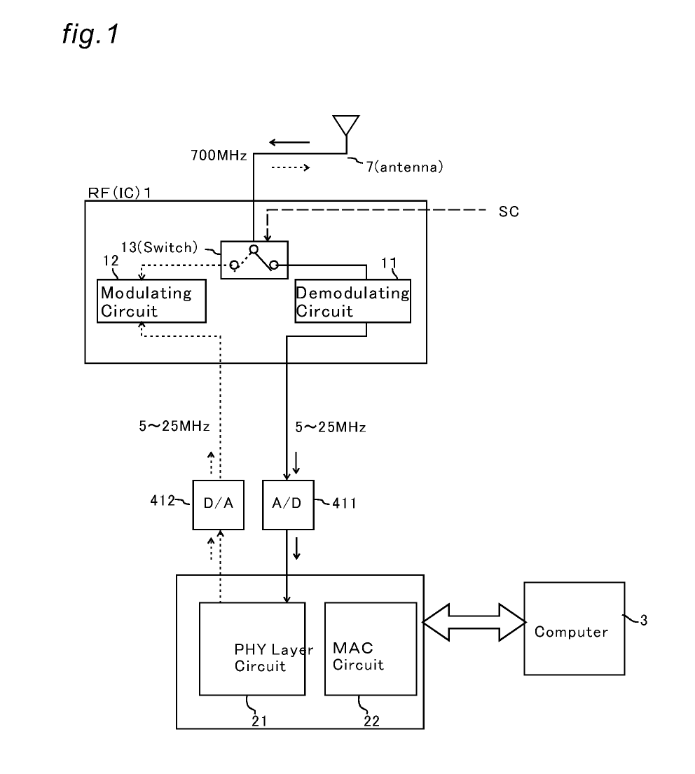

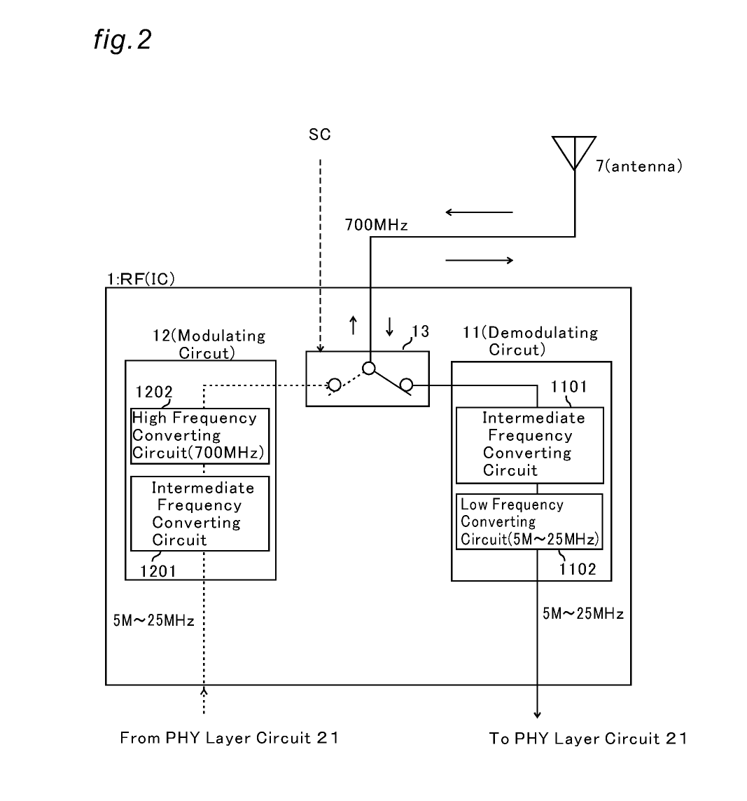

FIGS. 1 and 2 are illustrations showing the embodiments of the RF integrated circuit of the present invention. In FIG. 1, RF integrated circuit 1 comprises demodulation circuit 11, modulation circuit 12 and switching circuit 13. RF integrated circuit 1 is connected to circuit 2 comprising physical layer circuit 21 and MAC circuit 22, and circuit 2 is connected to computer 3.

Demodulation circuit 11 reduces a radio frequency band signal (here a signal of 715M-725 MHz) received by antenna 7 to arbitrary frequency (from 5 MHz 20 MHz), and it is output in physical layer circuit 21. Modulation circuit 12 raises a signal of arbitrary frequency (from 5 MHz 20 MHz) input from physical layer circuit 21 in a radio frequency (a signal of 715M-725 MHz), and it is output to antenna 7.

Physical layer circuit 21 is typically an interface circuit. In this embodiment, tt is provided with A/D converter 411, Digital to Analog converter 412 between physical layer circuit 21 and RF integrated circuit 1, but it can be established in physical layer circuit 21, and it can be made for RF integrated circuit 1. Physical layer circuit 21 is connected to MAC circuit 22, and the signal from demodulation circuit 11 is constructed across MAC circuit 22, and the signal from MAC circuit 22 is constructed across modulation circuit 12. Antenna 7 is connected to demodulation circuit 11 and modulation circuit 12 through switching circuit 13. Switching circuit 13 can change antenna 7 to either of demodulation circuit 11 and modulation circuit 12 by change signal SC from the outside.

Note that, demodulation circuit 11 can be comprised from intermediate frequency converter circuit 1101 and low frequency converter circuit 1102 as shown in FIG. 2. Intermediate frequency converter circuit 1101 converts a radio frequency signal input through switching circuit 13 into intermediate frequency, and it is further converted into frequency of around 5-25 MHz by low frequency converter circuit 1102. And, these frequency signals our particular frequency signal is output in physical layer circuit 21 of FIG. 1. Also, as shown in FIG. 2, modulation circuit 12 can be further comprised from high frequency converter circuit 1202 with intermediate frequency converter circuit 1201. The particular frequency signal of frequency signals from physical layer circuit 21 is converted into intermediate frequency by intermediate frequency converter circuit 1201. Even more particularly, a signal of this intermediate frequency is modulated to the signal of the radio frequency (a 700 MHz zone) by high frequency converter circuit 1202, and, through switching circuit 13, it is output to antenna 7.

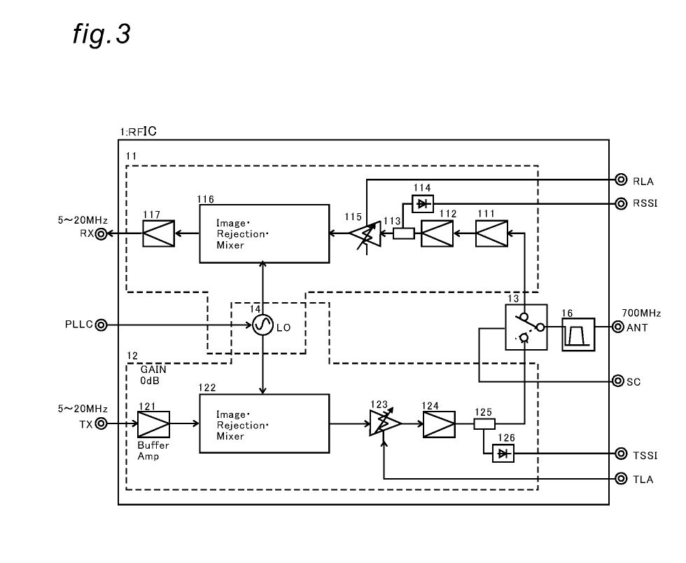

An embodiment of RF integrated circuit 1 of the present invention is shown in FIG. 3. Switching circuit 13 is set for (at the time of the reception) at the time of the recovery in the side as shown in the solid line by control signal SC. Demodulation circuit 11 comprises low noise amplifier 111, amplifier 112 for receive signal level adjustment, splitter 113, received signal strength detector 114, variable gain device 115, image f\check{S}fWfFfNfVf‡f″ Ef˜fLfT 116 and power amplifier 117.

The signal of the frequency 700 MHz zone from antenna terminal ANT is input into image f\check{S}fWfFfNfVf‡f″ Ef˜fLfT 116 through BPF (a bandpass filter) 16 and low noise amplifier 111, amplifier 112 for receive signal level adjustment and variable gain device 115. It is made a share wave by splitter 113, and the output of amplifier 112 for receive signal level adjustment is output from RSSI terminal through received signal strength detector 114 by an outside control unit (it is not illustrated). This control unit generates a gain adjustment signal of variable gain device 115 based on an input signal. RF integrated circuit 1 inputs this gain adjustment signal from reception level adjustment signal terminal RLA, and variable gain device 115 is operated.

Image f\check{S}fWfFfNfVf‡f″ Ef˜fLfT 116 inputs an output signal of variable gain device 115, and it regains its health. These demodulated signals are amplified by power amplifier 117, and it is sent out to physical layer circuit 21 (cf. FIG. 1) through A/D converter 411 (cf. FIG. 1) by receive signal terminal RX.

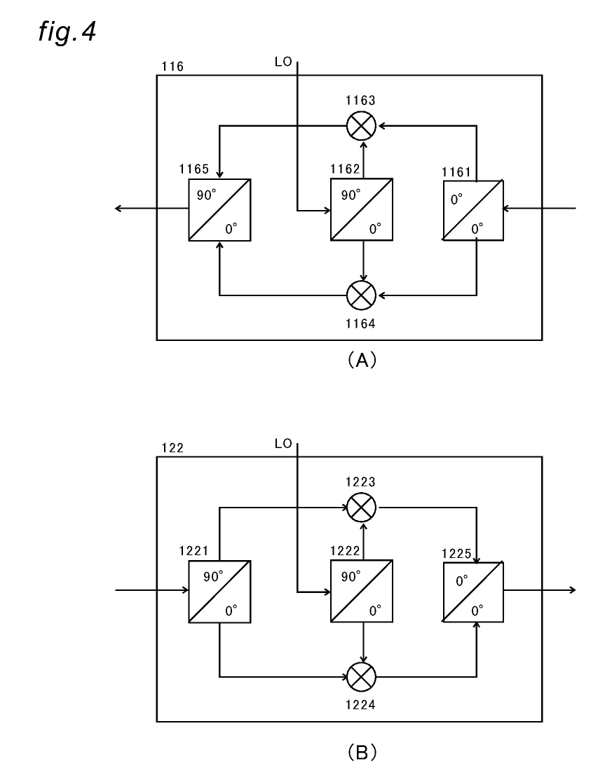

Image f\check{S}fWfFfNfVf‡f″ Ef˜fLfT 116 consists of splitter 1161 and phase shifter 1162 and mixer 1163, 1164 and synthesizer 1165 as shown in FIG. 4 (A). Splitter 1161 performs a share wave of an input signal to two signals of the aspect, and it is sent out to mixer 1163, 1164. The signal from local oscillator 14 is input into phase shifter 1162, and phase shifter 1162 outputs two signals that phase shifting is different 90 degrees to mixer 1163, 1164. Herein, mixer 1163 mixes a signal of the 90 degrees phase shifting from phase shifter 1162 with a signal from splitter 1161, and it is sent to synthesizer 1165. Mixer 1164 mixes a signal of the 0 degrees phase shifting from phase shifter 1162 with a signal from splitter 1161, and it is sent to synthesizer 1165. The signal which made a signal from mixer 1164 make 90 degrees phase shifting with synthesizer 1165 and a signal from mixer 1164 are synthesized, and it is output to power amplifier 117.

Switching circuit 13 is set for (at the time of the transmission) at the time of abnormality in the side as shown in the dotted line by control signal SC. Modulation circuit 12 comprises buffer amplifier 121, image f\check{S}fWfFfNfVf‡f″ Ef˜fLfT 122, variable gain device 123, power amplifier 124, splitter 125 and transmission signal strength detector 126.

After it is input through buffer amplifier 121 of gain 0 dB in image f\check{S}fWfFfNfVf‡f″ Ef˜fLfT 122, and it was performed frequency modulation in image f\check{S}fWfFfNfVf‡f″ Ef˜fLfT 122 by transmit signal input terminal TX, the signal of frequency 20 MHz from physical layer circuit 21 (cf. FIG. 1) is amplified by variable gain device 123 and power amplifier 124. And, it is output to antenna 7 (cf. FIG. 1) through switching circuit 13 and BPF (a bandpass filter) 16 by antenna terminal ANT. It is made a share wave by splitter 125, and the output of power amplifier 124 is output from TSSI terminal through transmission signal strength detector 126 by an outside control unit (it is not illustrated). This control unit generates a gain adjustment signal of variable gain device 123 based on an input signal. RF integrated circuit 1 inputs this gain adjustment signal from transmission level adjustment signal terminal TLA, and variable gain device 123 is operated.

Image f\check{S}fWfFfNfVf‡f″ Ef˜fLfT 122 consists of splitter 1221 and phase shifter 1222 and mixer 1223, 1224 and synthesizer 1225 as shown in FIG. 4 (B). Splitter 1221 performs a share wave of an input signal to two signals of the aspect, and it is sent out to mixer 1223, 1224. The signal from local oscillator 14 is input into phase shifter 1222, and phase shifter 1222 outputs two signals that phase shifting is different 90 degrees to mixer 1223, 1224. Herein, mixer 1223 mixes a signal of the 90 degrees phase shifting from phase shifter 1222 with a signal from splitter 1221, and it is sent to synthesizer 1225. Mixer 1224 mixes a signal of the 0 degrees phase shifting from phase shifter 1222 with a signal from splitter 1221, and it is sent to synthesizer 1225. The signal which made a signal from mixer 1224 make 90 degrees phase shifting with synthesizer 1225 and a signal from mixer 1224 are synthesized, and it is output to power amplifier 124.

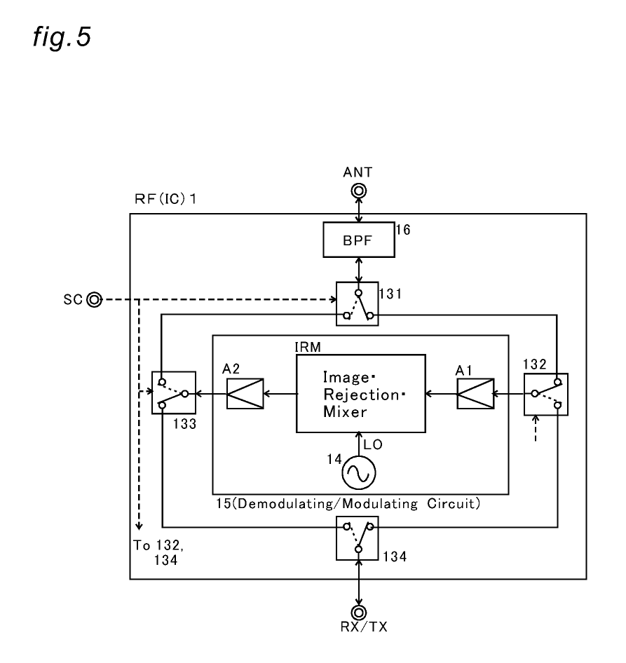

FIG. 5 is a conceptual diagram of the principle which shows the return modulation circuit which shares a modulation circuit with a demodulation circuit in an RF integrated circuit of the present invention by one circuit. RF integrated circuit 1 comprises working switching circuit 131,132,133,134 and return modulation circuit 15. Return modulation circuit 15 becomes low noise amplifier A1 and image f\check{S}fWfFfNfVf‡f″ Ef˜fLfT IRM from local oscillator 14 and power amplifier A2.

At the time of the recovery, switching circuit 131,132,133,134 is set in the side as shown in the solid line by control signal SC, respectively, and the signal of the frequency 700 MHz zone received by antenna 7 (cf. FIG. 1) is input into RF integrated circuit 1 by antenna terminal ANT. That is, the receive signal is input into image f\check{S}fWfFfNfVf‡f″ Ef˜fLfT IRM through BPF16, switching circuit 131, switching circuit 132, low noise amplifier A1. In image f\check{S}fWfFfNfVf‡f″ Ef˜fLfT IRM, an input signal is converted into a low frequency signal (5-25 MHz) using local oscillation signal LO from local oscillator 14. And, this low frequency signal is sent out to physical layer circuit 21 (cf. FIG. 1) through A/D converter 411 (cf. FIG. 1) by way of power amplifier A2, switching circuit 133, switching circuit 134 by transmission/receive signal input and output terminal RX/TX.

At the time of the abnormality, switching circuit 131,132,133,134 is set in the side as shown in the dotted line by control signal SC, respectively, and the transmit signal (5-25 MHz) that went by way of Digital to Analog converter 412 (cf. FIG. 1) from physical layer circuit 21 (cf. FIG. 1) is input into RF integrated circuit 1 by transmission/receive signal input and output terminal RX/TX. That is, the transmit signal is input into image f\check{S}fWfFfNfVf‡f″ Ef˜fLfT IRM through switching circuit 134, switching circuit 132, low noise amplifier A1. In image f\check{S}fWfFfNfVf‡f″ Ef˜fLfT IRM, an input signal is converted into a high frequency signal (the signal of the frequency 700 MHz zone) using local oscillation signal LO from local oscillator 14. And, this high frequency signal is sent out to antenna 7 (cf. FIG. 1) via power amplifier A2, switching circuit 133, switching circuit 131, BPF16 by antenna terminal ANT.

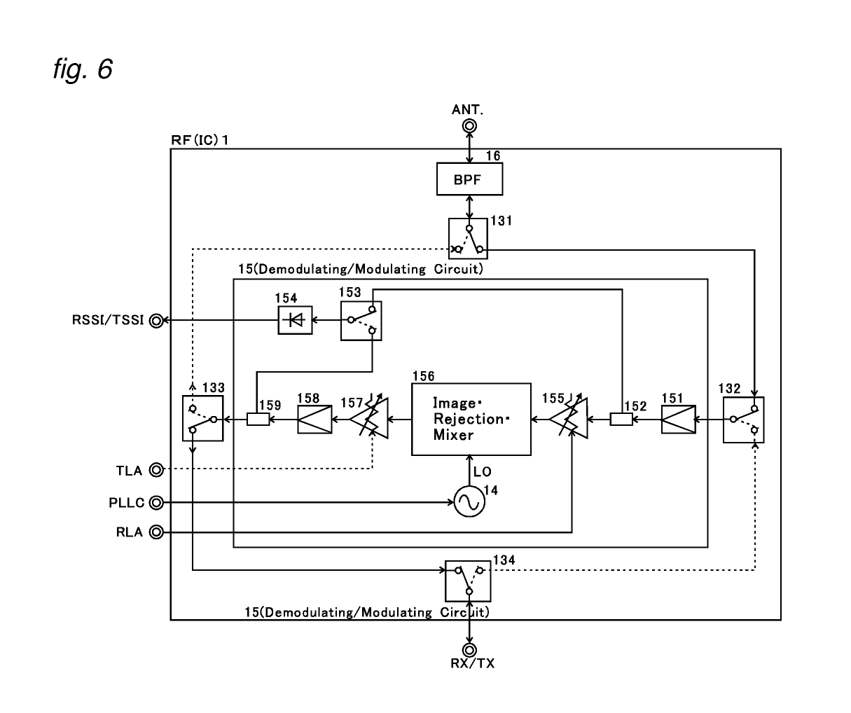

FIG. 6 is an illustration shown in the details with RF integrated circuit 1 of FIG. 5 more. In FIG. 6, in return modulation circuit 15, it is from signal strength detector 154 and variable gain device 155 and image f\check{S}fWfFfNfVf‡f″ Ef˜fLfT 156 and variable gain device 157 and power amplifier 158 and splitter 159 and local oscillator 14 with low noise amplifier 151 and splitter 152 and switching circuit 153.

In return modulation circuit 15 of FIG. 6, switching circuit 131,132,133,134 and switching circuit 153 is set at the time of the recovery in the side as shown in the solid line by control signal SC, respectively, and the signal of the frequency 700 MHz zone received by antenna 7 (cf. FIG. 1) is input into RF integrated circuit 1 by antenna terminal ANT. That is, the receive signal is input into BPF16, switching circuit 131, switching circuit 132, low noise amplifier 151, splitter 152, variable gain device 155. The signal performed a share wave of by splitter 152 is input into signal strength detector 154 through switching circuit 153, and the signal from signal strength detector 154 is sent out to the control unit which is not illustrated by reception/transmit signal intensity signals output terminal RSSI/TSSI. With this control unit, a reception level adjustment signal is generated. This reception level adjustment signal is input into a control terminal of variable gain device 155 by reception level adjustment signal terminal RLA, and a gain of variable gain device 155 is adjusted.

In image f\check{S}fWfFfNfVf‡f″ Ef˜fLfT 156, a signal from variable gain device 155 is converted into a low frequency signal (5-25 MHz) using local oscillation signal LO from local oscillator 14. And, this low frequency signal is sent out to physical layer circuit 21 (cf. FIG. 1) through A/D converter 411 (cf. FIG. 1) by way of variable gain device 157, power amplifier 158, splitter 159, switching circuit 133, switching circuit 134 by transmission/receive signal input and output terminal RX/TX. Note that, in this embodiment, at the time of the recovery, indicating signal of gain zero (0 db) is input into a control terminal of variable gain device 157.

In return modulation circuit 15 of FIG. 6, switching circuit 131,132,133,134 and switching circuit 153 is set at the time of the abnormality in the side as shown in the dotted line by control signal SC, respectively, and the transmit signal (5-25 MHz) that went by way of Digital to Analog converter 412 (cf. FIG. 1) from physical layer circuit 21 (cf. FIG. 1) is input into RF integrated circuit 1 by transmission/receive signal input and output terminal RX/TX. That is, the receive signal is input into image f\check{S}fWfFfNfVf‡f″ Ef˜fLfT 156 through switching circuit 134, switching circuit 132, low noise amplifier 151, splitter 152, variable gain device 155. Note that, in this embodiment, at the time of the abnormality, indicating signal of gain zero (0 db) is input into a control terminal of variable gain device 155. In image f\check{S}fWfFfNfVf‡f″ Ef˜fLfT 156, an input signal is converted into a high frequency signal (the signal of the frequency 700 MHz zone) using local oscillation signal LO from local oscillator 14. And, this high frequency signal is sent out to variable gain device 157, power amplifier 158, splitter 159, switching circuit 133. The signal performed a share wave of by splitter 159 is input into signal strength detector 154 through switching circuit 153, and the signal from signal strength detector 154 is sent out to the control unit which is not illustrated by reception/transmit signal intensity signals output terminal RSSI/TSSI. With this control unit, a transmission level adjustment signal is generated. This transmission level adjustment signal is input into a control terminal of variable gain device 157 by transmission level adjustment signal terminal TLA, and a gain of variable gain device 157 is adjusted. And, the transmit signal from switching circuit 133 is sent out to antenna 17 (cf. FIG. 1) through switching circuit 131, BPF16 by antenna terminal ANT.

In the attached drawings, the following reference numerals correspond to:
1 RF integrated circuit
2 circuits
3 computers
5 frequency
7, 17 antennas
Eight or nine communications equipment
11 demodulation circuits
12 modulation circuits
13,131,132,133,134 14 switching circuit local oscillators
15 return modulation circuits
16 BPF
21, 82, 92 physical layer circuits
22, 83, 93 MAC circuit
81, 91 RF circuit
111 low noise amplifiers
An amplifier for 112 receive signal level adjustment
113, 125, 152, 159, 1161, 1221 114 splitter received signal strength detectors
115,123,155,157 variable gain device
116,122,156, IRM image f\check{S}fWfFfNfVf‡f″ Ef˜fLfT
117,124,158, 121 A2 power amplifier buffer amplifiers
126 transmission signal strength detectors
151, A1 low noise amplifier
154 signal strength detectors
411 A/D converter
412 D/A converter
1101, 1201 intermediate frequency converter circuits
1102 low frequency converter circuits
1162, 1222 phase shifter
1163, 1164, 1223, 1224 mixer
1165, 1225 synthesizers
1202 high frequency converter circuits
ANT antenna terminal
LO local oscillation signal
RLA reception level adjustment signal terminal
RX receive signal terminal
SC change signal
TLA transmission level adjustment signal terminal
A TX transmit signal input terminal

I claim:

1. The RF integrated circuit including a radio frequency band signal received by an antenna is reduced to arbitrary frequency, and a signal of option frequency input into other circuits from a demodulation circuit to output and the circuit of above others is raised in a radio frequency, and it is an RF integrated circuit for the development that had the switching circuit which changes a modulation circuit to output and an above antenna to either of an above demodulation circuit and the above modulation circuit built-in, and the RF integrated circuit is made accumulation independently with the circuit of above others by an above antenna and the above demodulation circuit converts a received radio frequency signal into a frequency signal of frequency 5-20 MHz, and the above modulation circuit converting a frequency signal of frequency 5-20 MHz into a radio frequency signal.

2. The other circuits, an RF integrated circuit as claimed in claim 1 including the thing including media access control circuit connected to the physical layer circuit which AD conversion is performed between the demodulation circuit, and performs DA conversion between the modulation circuit and the physical layer circuit.

3. The RF integrated circuit including the thing comprising the switch circuitry which it is an RF integrated circuit as claimed in claim 1 that a return modulation circuit functioning as the demodulation circuit and the modulation circuit was built in, and the return modulation circuit changes the signal paths that at least send out the signal from a low noise amplifier and image f\check{S}fWfFfNfVf‡f″ Ef˜fLfT of the latter half and the signal paths that the power amplifier of the latter half is further included as common componentry, and send out the signal from an above antenna to an above physical layer circuit through the return modulation circuit and an above physical layer circuit to an above antenna through the return modulation circuit to.
